(19) United States
(12) Patent Application Publication
(10) Pub. No.: US 2003/0038883 A1
(43) Pub. Date: Feb. 27, 2003

(54) Apparatus, system and method for providing frame rate measuring information of image data

(76) Inventors: Kyosuke Takahashi, Ome-shi (JP); Akihisa Fujimoto, Fussa-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/224,274

(22) Filed: Aug. 21, 2002

(30) Foreign Application Priority Data
Aug. 22, 2001 (JP) 2001-251768

(51) Int. Cl. H04N 5/225

(52) U.S. Cl. 348/207.1; 348/211.99

(57) ABSTRACT

A system is disclosed which comprises a combination of a camera module with a host system for processing image data. The host system receives the image data as frame rate measuring information from the camera module and measures the frame rate with the use of the image data. The host system is so configured as to, if the measured frame rate is not fitted to a transfer rate specification of the system, control the camera module and adjust the frame rate of the image data.

### CROSS-REFERENCE TO RELATED APPLICATIONS

This application is based upon and claims the benefit of priority from the prior Japanese Patent Application No. 2001-251768, filed Aug. 22, 2001, the entire contents of which are incorporated herein by reference.

### BACKGROUND OF THE INVENTION

1. Field of the Invention

The present invention relates generally to a digital camera art and, in particular, to a camera module equipped with a function to output frame rate measuring information to an outside.

2. Description of the Related Art

In recent years, various kinds of card modules removably mounted on an electronic device (here simply sometimes referred to as a system or host system), such as a personal computer, a hand-held telephone unit or a mobile information unit, have been developed.

Of these card modules, there is a camera module realizing a digital camera function. The camera module comprises a card-like substrate serving as a module body and constituent elements, such as an image taking system and a control system, formed on the substrate and realizing a digital camera function. This camera module has the function of outputting taken image data (a still image or a moving image).

The host system has a removably mounted camera module and can store image data obtained from the camera module or transfer it to another system by utilizing a communication function (including a hand-held telephone unit, etc.).

Incidentally, the host system controls the camera module normally under the run of a predetermined application program (here simply referred to as an application) and processes (utilizes) the image data taken from the camera module. Here, it is not possible to uniquely determine any combination of the camera module with the host system. For this reason, it is not always appropriate to take such a combination under an operating system (OS) of the host system and under an interface specification, etc. Under a practical level operation of the application in particular, the specification relating to the frame rate of the image data is important in the system connected to the camera module.

For the host system and a system combined with the camera module it is important to fit the frame rate of the image data to the specification of the application. In other wards, under a practical level operation of the application, it is necessary to set (effect an optimal setting of the camera configuration information) a camera module's operation specification under which the frame rate of the image data required is realized.

In the conventional technique, it is not easy to simply set the camera module's operation specification from a host system side. In other words, a method by which a combination of the host system and camera module can be realized under a practical level has not been developed.

As the prior art technique, a proposal is made by which the data amount of an image signal is converted and a corresponding output is supplied to a host system (for example, see Jpn. Pat. Appln. KOKAI Publication No. 2000-83253). Further, another proposal is also made by which a data transfer rate and computer's calculation capacity are measured to determine an operation mode (for example, see Jpn. Pat. Appln. KOKAI Publication No. 10-178649). However, these techniques are established on a fixed system structure in the combination of a camera module and host system. It is not easy, however, to determine the operation mode of the camera module on any host system of a different performance with the use of the conventional technique.

### BRIEF SUMMARY OF THE INVENTION

In accordance with one aspect of the present invention there is provided a camera module including facilities to measure frame rates of image data, comprising a module body having mounted constituent elements configured to realize a camera function; an interface mounted in the module body and configured to output image data generated under the camera function; and a providing means configured to provide frame rate measuring information of the image data to an external system connected to the interface.

### BRIEF DESCRIPTION OF THE SEVERAL VIEWS OF THE DRAWING

FIG. 1 is a block diagram showing a major section of a camera module relating to an embodiment of the present invention;

FIG. 2 is a view for explaining camera configuration information (1, . . . , N) relating to the embodiment;

FIGS. 3A and 3B are views for explaining a determining factor of a frame rate of image data relating to the embodiment;

FIGS. 4A and 4B are views for explaining a first measuring method of the transfer rate relating to the embodiment;

FIG. 5 is a view for explaining a second measuring method of a transfer rate relating to the embodiment;

FIG. 6 is a view for explaining a third measuring method of a transfer rate relating to the embodiment;

FIG. 7 is a view for explaining a method for checking the reception of the image data of a frame unit relating to the embodiment;

FIG. 8 is a flow chart for explaining the operation of a system relating to the embodiment; and

FIG. 9 is a flow chart for explaining the operation of a system relating to a variant of the embodiment above.

### DETAILED DESCRIPTION OF THE INVENTION

An embodiment of the present invention will be described below with reference to the accompanying drawing.

Camera Module and System Structure

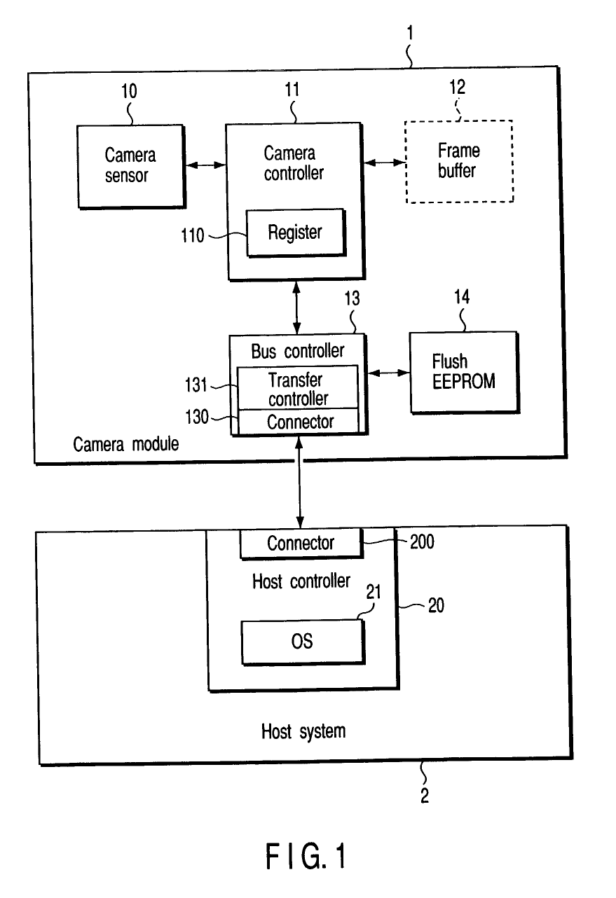

FIG. 1 is a block diagram showing a camera module and system structure relating to the present embodiment.

The camera module 1 comprises a structure in which digital camera function realizing elements are mounted on a card-like module body. It is assumed here that, as a digital camera function, it is also possible to perform image processing on a still image and moving image. In this embodiment, an explanation will be made below particularly about the handling of the moving image.

The respective elements mounted on the module body includes a camera sensor 10, a camera controller 11, a frame buffer 12, a bus controller 13 and a nonvolatile memory (for example, a flash EEPROM) 14.

The camera sensor 10 includes an optical lens system and image pickup processing system and generates image data in accordance with an operation mode (here, a moving image mode) and frame rate under the control of a camera controller 11. The image data is supplied as a digital video stream and has a signal quality (including a frame rate) determined by a camera configuration information set by the camera controller 11 as will be set out below. Here, the “frame rate” of the image data means the number of frames per unit time (usually fps: frame per second). The frame rate corresponds to a data transfer rate on the system side.

The camera controller 11 performs operation control of each element including a camera sensor 10. The camera controller 11 incorporates a plurality of registers 110 in it, stores the camera configuration information and performs control operation in accordance with the camera configuration information. It is to be noted that the register 110 may be provided in the camera sensor 10 or bus controller 13, not in the camera controller 11. In short, the camera controller 11 may take any form if it is configured to be capable of referring to the contents of the register 110.

The frame buffer 12 is comprised of a buffer memory for temporarily storing image data of a frame unit which is outputted from the camera sensor 10. It is to be noted that there is the case of providing no frame buffer as will be set out below. If no frame buffer 12 is provided, the camera controller 11 continuously transfers the image data which is obtained from the camera sensor 10 to the bus controller 13.

The bus controller 13 includes an interface for connecting between the camera module 1 and a host system 2. The bus controller 13 includes a connector 130 and a transfer controller 131 for controlling a transfer of the image data to the host system 2. The memory 14 constitutes a nonvolatile erasable memory for storing various kinds of control information including the camera configuration information, parameters, etc., as will be set out below. The host system 2 can refer to the stored contents of the memory 14 through the bus controller 13 and instruct a read operation to the memory 14.

The host system 2 means, for example, a personal computer, a handheld telephone unit or a mobile information unit such as a PDA, which has an interface removable from the camera module 1. The interface includes a connector 200 for connecting to the connector 130 of the camera module 1.

The host controller 20 includes a microprocessor (CPU), as a main element, for running an application for controlling the camera module 1 and processing on the image data. The application is run under the control of a predetermined OS 21 set in the host system 2 and has the function of measuring the frame rate of the image data relating to the present embodiment. Further, the application has a deciding function of deciding whether or not the measured frame rate is fitted to the system specification of the host system 2.

Operation of System

An explanation will be made below about the measuring operation and deciding operation on the frame rate relating to the embodiment as an operation of the system with the camera module 1 connected to the host system 2.

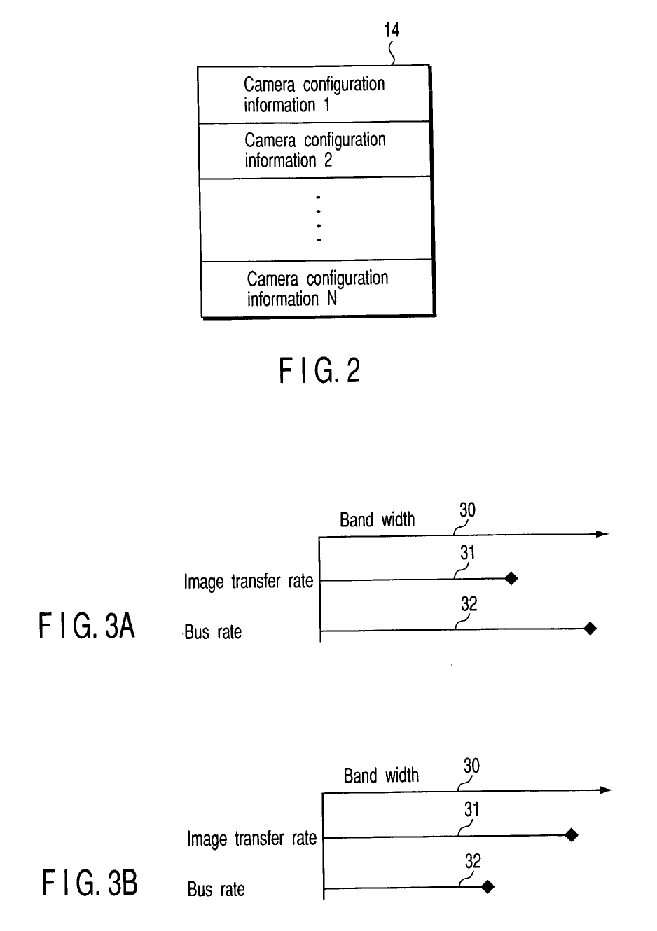

First, as shown in FIG. 2, a plurality of camera configuration information (1 . . . N) are initially stored in the memory 14 of the camera module 1. The camera configuration information contains information on a resolution, number of colors, an image compression format, image compression rate, etc., as well as a frame period, aspect ratio (height and width of an image), etc., which correspond to the camera's image capturing conditions (or video format setting information). Further, the camera configuration information also contains an operation mode (still image processing or moving image processing) but, here, moving image processing is assumed in this embodiment.

The camera configuration information constitutes the information as a determining factor of the frame rate of the image data. The camera configuration information are stored in a level order (the digit “1” means the maximal level) of the frame rates in the memory 14.

The application which is run by the host controller 20 can, while referring to the camera configuration information (1 to N), sequentially read them from the memory 14 and set them to the registers 110 of the camera controller 11.

Here, in the system with the camera module 1 connected to the host system 2, the transfer rate (frame rate) of the image data of the system as a whole is set by a determining factor of a transfer rate between the camera controller 11 and the bus controller 13 and a transfer rate between the bus controller 13 and the host controller 20.

FIG. 3A shows one example of the transfer rate 31 between the camera controller 11 and the bus controller 13, as well as a bus rate 32, with respect to a bandwidth 30 required of the system as a whole. If, such is the case, then the system can adequately extract the performance of the camera module 1. Further, FIG. 3B shows one example of the transfer rate 31 between the bus controller 13 and the host controller 20, as well as the bus rate 32, with respect to the bandwidth 30 required of the system as a whole. If such is the case, the system cannot fully draw out the performance of the camera module 1.

Incidentally, the factor of the transfer rate of the image data includes, in addition to the camera configuration information as set out above, the pixel clock, etc., of the camera module 1. As the factor of the bus rate are included the operation mode (bus width, transfer data length, block/byte unit) of a bus between the bus controller 13 and the host controller 20, a bus clock, kind of OSs, an overhead of interruption processing, etc.

Measuring Operation of Frame Rate

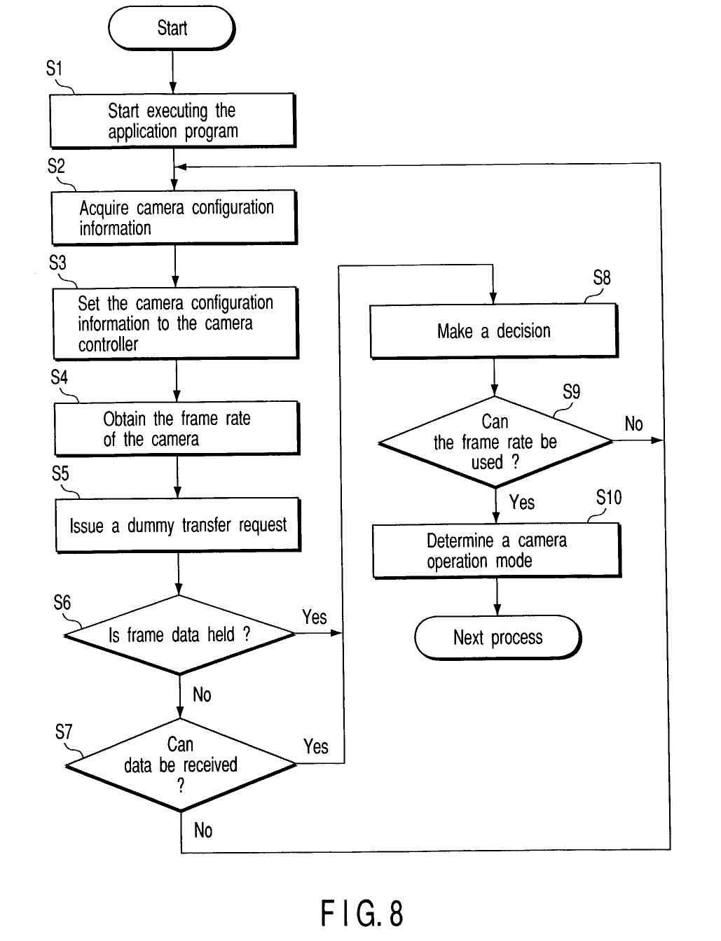

The process of measuring operation of the frame rate of the image data, as well as its deciding operation, under the application will be described below with reference to a flow chart of FIG. 8.

First, the measuring operation of the frame rate of the image data transferred from the camera module 1 is started (step 1) by starting the application of the host controller 20. A setting value calculated from the camera configuration information is set to the register 110 (step S2 and S3). The setting value is set from the host controller 20 via the bus controller 13 or by the camera controller 11 itself.

Then, the host controller 20 obtains a frame rate (corresponding to the transfer rate of the camera itself) inside the camera module 1 (step S4). The frame rate is a fixed value initially set inside the camera module 1 (for example, the memory 14) or a value measured by the measuring function of the camera controller 11.

Then, the host controller 20 forwards a dummy transfer request (command) for actually measuring a frame rate (transfer rate) of the system to the camera controller 11 (step S5). Upon receipt of this request, the camera controller 11 controls the camera sensor 10 in accordance with the camera configuration information set to the register 110 and outputs image data (for example, through image data) of dummy data.

Here, if the frame buffer 12 is provided, the camera controller 11 temporarily stores the image data which is outputted from the camera sensor 10 in the frame buffer 12 (YES at step S6). The camera controller 11 transfers the image data to the host controller 20 through the bus controller 13.

The host controller 20 actually measures the frame rate (transfer rate of the system as a whole) of the image data on the basis of the image data transferred from the camera module 1 as will be described in more detail below. The host controller 20 presents the actually measured frame rate to the application.

The application decides whether or not the actually measured frame rate is fitted to a practical use level (a transfer rate fitted to the system specification)—step S8. If a result of decision is utilizable as a practical use level, the host controller 20 treats the set camera configuration information as being effective and decides a camera operation mode (here, moving image processing) required of the application (YES at step S9, step S10).

Further, the host system 2 receives the image data transferred from the camera module 1 and performs processing based on the specification of the application. If, on the other hand, a result of decision is unfit, the host controller 20 reads the next camera configuration information (for example, number 2 information) from the memory 14 and changes the information set on the register 110 of the camera controller 11 (NO at step S9). And the host controller 20 repeats the above-mentioned actual frame rate measurement and decision proceeding.

If, here, no frame buffer 12 is provided in the camera module 1, the host controller 20 decides whether or not the reception of the image data of a frame unit is secured (NO at step S6, step S7). Stated in more detail, in accordance with the reception of the image data, the host controller 20 checks those frame identification values (N, N+1, . . . ) stored in the registers 110 in the camera controller 11. That is, checking is made to see whether or not the frame identification values are continuous before and after the data reception (see FIG. 7). Suppose that the frame identification values are not continuous, then it is decided that the frame of the frame unit image data is not secured (NO at step S7). In this case, the host controller 20 reads the next camera configuration information (for example, No. 2 information) from the memory 14 and changes the information set to the register 110 in the camera controller 11 (NO at step S9).

Actual Measuring Method of Frame Rate

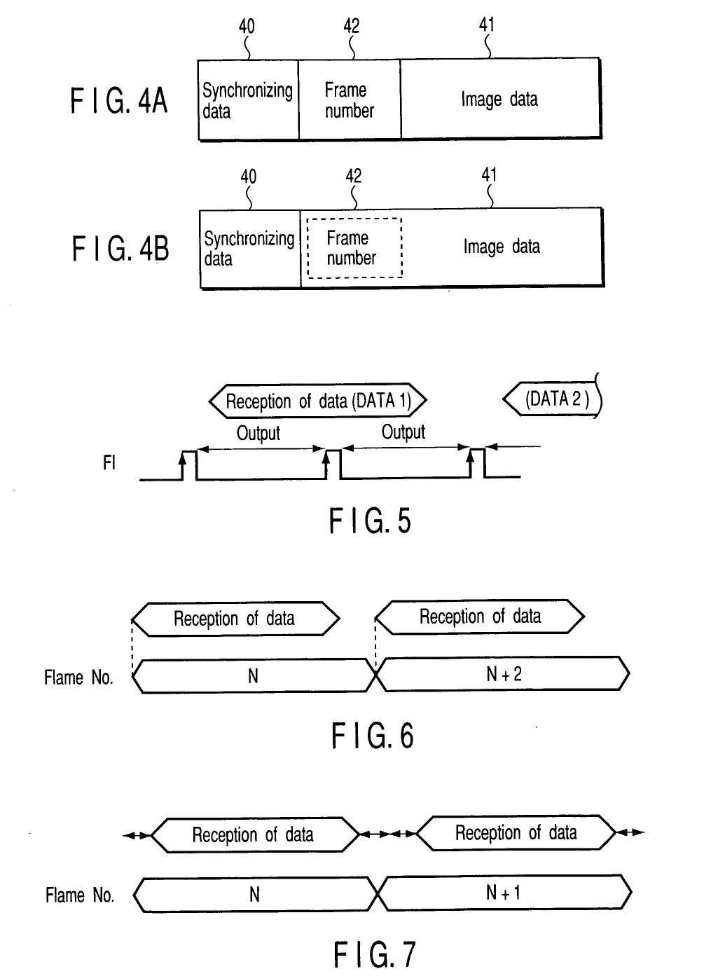

The measuring method of the frame rate will be explained below with reference to FIGS. 4A, 4B, 5 and 6.

A first measuring method will be explained below with reference to FIGS. 4A and 4B.

The camera controller 11 transfers data to the host controller 20 with a frame identification value (for example, a frame number) 42 added to the frame unit image data as shown in FIG. 4A. Here, synchronizing data 40 constitutes data for identifying the frame unit image data.

The host controller 20 checks the frame identification value 42 of the image data transferred from the bus controller 13 and calculates a frame rate based on a result of checking. It is to be noted that, as shown in FIG. 4B, the camera controller 11 may transfer data to the host controller 20 with a frame identification value 42 included in the image data 41.

Now a second measuring method will be explained below with reference to FIG. 5.

As shown in FIG. 5, the camera controller 11 outputs a frame synchronizing (vertical synchronizing) signal FI to the camera sensor 10 at a time of taking an image. The host controller 20 counts the number of interruptions by the frame synchronizing signal FI and number of received data. The host controller 20 counts the frame rate based on the respective count values.

Here, in the case where the camera module 1 actually measures the frame rate with the use of the frame identification value, the camera controller 11 is so configured as to count the number of interruptions involved.

The third measuring method will be explained below with reference to FIG. 6.

As shown in FIG. 6, the camera controller 11 allows frame identification values (N, N+1, . . . ) which are outputted from the camera sensor 10 to be stored in the registers 110. The host controller 20 calculates the frame rate by checking the frame identification values (N, N+1, . . . ) stored in the registers 110.

It is to be noted that, by checking the frame identification values (N, N+1, . . . ) stored in the registers 110 as set out above, the host controller 20 can also check image data corresponding to a frame dropped without being transferred (see FIG. 7).

In short, according to the embodiment, the frame rate (transfer rate) of the image data which is transferred from the camera module 1 can be measured in accordance with a change of the camera configuration information of the camera module 1. In other words, the host system 2 can obtain, from the camera module 1 used in combination therewith, the information (Concretely, the image data and frame identification value) for measuring the transfer rate of the image data of the system as a whole.

Based on the result of measurement, the host system 2 can decide whether or not the frame rate (transfer rate) is fitted to a practical level when the application is utilized. If the measured transfer rate is not fitted, the host system 2 can sequentially change the camera configuration information and, by doing so, adjust the transfer rate as a result of this. Since, by doing so, it is possible to set the transfer rate of the image data fitted to the application of the host system 2, a practical system can be provided which is fitted to the operation specification of the camera module.

Variant

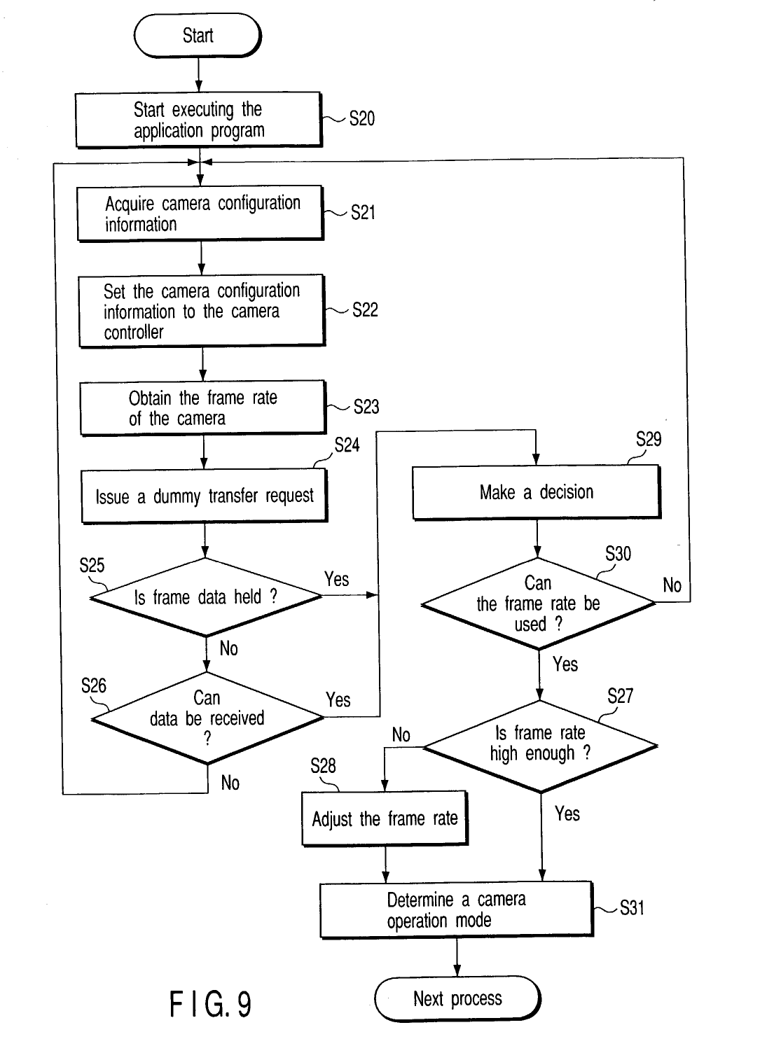

FIG. 9 shows a flow chart relating to a variant of the present embodiment.

The variant is so configured as to, in the case where a camera controller 11 has an adjust function, perform fine adjustment processing, under the adjust function, on the measuring process of the frame rate (transfer rate).

In the camera module 1, as the adjust (fine adjust) items are included a pixel clock adjustment (realized by a PLL circuit), an adjustment of an image compression ratio, an adjustment of a resolution (trimming), etc. The adjust function relating to the variant constitutes the function of making a fine adjustment of the frame rate by the adjustment of a pixel clock frequency and a variation of an image compression ratio. The process of the present variant will be described below with reference to FIG. 9.

First, the measuring operation of a transfer rate of image data transferred from the camera module 1 is started (step S20) by starting an application of a host controller 20. The host controller 20 reads out camera configuration information (for example, No. 1 information) from a memory 14 in the camera module 1 and sets it in a register 110 of the camera controller 11 (steps S21, S22).

The host controller 20 forwards a dummy transfer request to the camera controller 11 and starts the measurement of a frame rate of the system (steps S23, S24). In the case where, here, no frame buffer 12 is provided in the camera module 1, the host controller 20 decides whether or not the reception of frame-unit image data is secured (step S26). In the case where, as a result of decision, the transfer of the frame-unit image data is not secured at a practical level, the host controller 20 re-sets camera configuration information and processing from step S23 is repeated (NO at step S26).

In the case where the frame buffer 12 is provided in the camera module 1, the decision processing at the practical level and decision of the utilizability are performed (step S29, S30) as in the case of the above-mentioned embodiment. If the result of the decision is utilizable at a practical level, the host controller 20 sets the camera configuration information to be effective and determines a camera operation mode (here, moving image processing) requested of the application (YES at step S27, S31).

Even if it is as being utilizable and available, the host controller 20 can make a fine adjustment of a frame rate (NO at step S27, S28) in the adjust-function-equipped camera module in the case where there is no frame rate margin. Stated in more detail, for example, the frame rate is fine adjusted by the adjustment of a pixel clock frequency and change of an image compression ratio.

It is to be noted that, in the case where the result of decision is not fitted, the host controller 20 reads out the next camera configuration information (for example, No. 2 information from the memory 14 and re-sets it in the register 110 in the camera controller 11 (NO at step S30). And the host controller 20 repeats the actual measurement of the above-mentioned frame rate and decision processing.

In short, according to the present variant, the actual measurement and adjustment of the frame rate fitted to the system specification can be enhanced to a practical available level through the joint utilization of the adjust function (fine adjustment function of the frame rate) of the camera module 1.

In short, according to the present invention, under a combined system between the camera module and the host system, the host system can measure the frame rate of the image data by performing a camera operation of the camera module. In other word, under a combination with the camera module, the system can measure the frame rate of the image data. Thus, the application of the host system can make a comparison between a frame rate fitted to a practical level operation under the system specification and a result of its measurement and decide whether or not the result of the measurement can be applied.

Further, the host system can adjust the frame rate of the camera module so as to be fitted to the specification of the application. That is, the application of the host system properly sets the fine adjustment items of the camera through the adjust function of the camera module and, as a result, can make a fine adjustment so as to fit the frame rate of the image data to the system specification.

The present invention can be applied practically to a personal computer, a hand-held telephone unit or a mobile information unit such as a PDA. The above-mentioned system measures a frame rate relative to the camera module which is incorporated at a time of starting the application, and re-sets the configuration information of the camera module so as to set a fit frame rate. Even if the system specification is not uniquely determined, the operation specification of the camera module is re-set and, by doing so, the fame rate of the image data can be adjusted to be matched to the system specification.

What is claimed is:

1. An apparatus comprising:
a module body;
an interface mounted in the module body and configured to output image data to an external system; and
a controller configured to provide frame rate measuring information of the image data to the external system connected to the interface.

2. An apparatus according to claim 1, furthermore comprising a camera sensor configured to realize an image capturing function, wherein said controller includes a camera controller configured to control the camera sensor.

3. An apparatus according to claim 1, wherein the interface includes a connector removably mounted relative to the external system and a transfer controller configured to transfer the image data to the external system via the connector.

4. An apparatus according to claim 1, wherein the interface and said controller are integrated into a common chip and incorporated into the module body.

5. An apparatus according to claim 1, wherein said controller includes a memory related to a decision of the frame rate and configured to store camera configuration information which decides an operation specification of the digital camera function, and the external system is configured to refer to camera configuration information by gaining access to a memory via the interface.

6. An apparatus according to claim 1, wherein said controller includes a memory relating to a decision of the frame rate and configured to store a plurality of camera configuration information which decide an operation specification of the digital camera function, and the external system is configured to refer to the respective camera configuration information by gaining access to the memory via the interface.

7. An apparatus according to claim 1, wherein said controller is configured to provide, as the frame rate measuring information, frame identification information identifying the frame of the image data or image data with the frame identification information added thereto to the external system via the interface.

8. An apparatus according to claim 1, wherein said controller is configured to control a camera operation in accordance with the camera configuration information selectively set by the external system and transfer the frame rate measuring information to the external system via the interface.

9. An apparatus according to claim 1, wherein said controller includes a camera controller configured to control a camera operation in accordance with camera configuration information and the camera controller has an adjust function to realize a fine adjusting function of the frame rate included in the camera operation.

10. An apparatus according to claim 1, wherein the module body includes a frame memory configured to store the image data of a frame unit generated under the digital camera function.

11. A system for processing image data, comprising:
a camera module configured to output image data and store camera configuration information which decide an operation specification of a camera function, the camera configuration information being accessible so as to refer thereto;
an interface removably connected to the camera module and configured to transfer the camera configuration information from the camera module; and
a controller configured to selectively set a camera configuration information to the camera module through the interface, in accordance with the camera configuration information.

12. A system according to claim 11, wherein said controller decides whether or not the measured frame rate is fitted to a transfer rate specification of the system.

13. A system according to claim 11, wherein said controller decides whether or not the measured frame rate is fitted to a transfer rate specification of the system and, when a result of decision is not fitted, re-sets the camera configuration information and again performs the measurement operation of the frame rate.

14. A system according to claim 11, wherein said controller is configured to receive frame identification information of the image data transferred from the camera module, or image data with the frame identification information added thereto via the interface and measure the frame rate by using the frame identification information.

15. A system according to claim 11, wherein said controller includes a counting means configured to count the number of interruptions by a frame synchronizing signal transferred from the camera module and measures the frame rate based on the count value.

16. A system according to claim 11, wherein said controller counts the number of received data of a frame unit transferred from the camera module and, based on the count value, checks the received data for integrity.

17. A system according to claim 11, wherein said controller makes a comparison between the frame rate measured in the camera module and the measured frame rate and, based on the result of comparison, decides the frame rate for fitness.

18. A system according to claim 11, wherein the camera module has an adjust function to realize a fine adjustment function of the frame rate included in a camera operation and said controller adjusts the frame rate, under the adjust function, in accordance with an extent of the measured frame rate.

19. A method for receiving a image data which is transferred from a module operated in accordance with a configuration information, comprising:
a step of setting configuration information which relates to a decision of a frame rate of image data; and
a step of transferring the configuration information to an external system,

20. A method according to claim 19, further comprising a step of, based on a result of measurement of the frame rate, deciding whether or not the frame rate of the image data is fitted to the specification of the system.
